(19) United States
(12) Patent Application Publication
(10) Pub. No.: US 2017/0038037 A1
(43) Pub. Date: Feb. 9, 2017

(54) LED STRIP HOUSING APPARATUS

(71) Applicant: NINGBO HAIDER IMPORT AND EXPORT CO., LIMITED, Ningbo (CN)

(72) Inventor: Mark SUTHERLAND, Calgary (CA)

(21) Appl. No.: 15/230,595

(22) Filed: Aug. 8, 2016

Related U.S. Application Data
(60) Provisional application No. 62/202,360, filed on Aug. 7, 2015.

(51) Int. Cl. F21V 15/015; F21V 23/06; F21V 19/00; F21V 3/02

(52) U.S. Cl. CPC F21V 15/015; F21V 3/02; F21V 23/06; F21V 19/005; F21Y 2113/10

(57) ABSTRACT

There is disclosed an LED strip housing apparatus, comprising: a generally elongate tube providing space for electric wiring, circuit boards and electronics; and an LED strip carrier receiving channel provided adjacent to the generally elongate tube and adapted to slideably receive an LED strip carrier. In an embodiment, the LED strip housing apparatus further comprises an outer cover receiving channel for slideably receiving an outer cover which covers and protects the LED strip carrier received within the LED strip carrier receiving channel. In another embodiment, the LED strip housing apparatus further includes end caps mounted to either end of the housing, the end caps adapted to connect the LED strip to wiring, circuit boards and electronics within the rectangular tube.

### FIELD

The present disclosure relates to strips, and more particularly to a strip housing apparatus for light emitting diodes (LEDs).

### BACKGROUND

LED lighting requires a mounting configuration that allows the LED element to be properly positioned and aligned for desired performance. However, mounting LEDs onto existing strips may require multiple steps involving removal and installation or reinstallation of various fasteners and covers. Where there are numerous lighting elements to be replaced, for example in an office building, such steps may be cumbersome and may make lighting maintenance inefficient.

What is therefore needed is an improved LED strip design which addresses these limitations in the prior art

### SUMMARY

The present disclosure relates to an LED strip housing apparatus which allows an LED strip carrier to be slideably inserted into or removed from an LED strip carrier receiving channel.

In an aspect, the LED strip carrier receiving channel of the LED strip apparatus includes retaining flanges which allow an LED strip carrier to be slideably inserted or removed from one end of the LED strip apparatus while the other end of the strip apparatus remains covered with an end cap.

In another aspect, the LED strip carrier receiving channel of the LED strip apparatus is accessible from one end of the apparatus with one end cap removed, while a light cover remains installed in position over the length of the LED strip carrier receiving channel.

In another aspect, the end caps are adapted to include plug-in connectors which allow an electrical connection to the LEDs on the LED strip carrier simply by installing the end caps in position.

In another aspect, the LED grip carrier is readily exchangeable with another LED strip carrier of the same size, but having LEDs with different luminosity or colors mounted thereon, suitable for a different lighting environments or applications.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1A shows an illustrative perspective view of an LED strip housing in accordance with an illustrative embodiment.

FIG. 1B shows an illustrative detailed view of the LED strip housing of FIG. 1A.

FIG. 2 shows a detailed cross-sectional view of the LED strip housing of FIGS. 1A and 1B, including an LED strip carrier receiving channel in accordance with an illustrative embodiment.

FIGS. 3A and 3B show perspective views of end caps in accordance with an illustrative embodiment.

FIG. 4A shows a perspective view of an LED strip carrier in accordance with an illustrative embodiment.

FIG. 4B shows a detailed perspective view of the LED strip carrier of FIG. 4A.

FIG. 4C shows a detailed cross-sectional view of the LED strip carrier of FIGS. 4A and 4B.

FIG. 5A shows an illustrative perspective view of an LED strip housing in accordance with another illustrative embodiment.

FIG. 5B shows a detailed cross-sectional view of the LED strip housing of FIG. 5A.

### DETAILED DESCRIPTION

As noted above, the present disclosure relates to an LED strip housing apparatus which allows an LED strip carrier to be slideably ins removed from an LED strip carrier receiving channel.

In an aspect, the LED strip carrier receiving channel of the LED strip housing apparatus includes retaining flanges which allow an LED strip carrier to be slideably inserted or removed from one end of the LED strip apparatus while the other end of the strip apparatus remains covered with an end cap.

In another aspect, the LED strip carrier receiving channel of the LED strip housing apparatus is accessible from one end of the apparatus with one end cap removed, while an outer cover remains installed in position over the length of the LED strip carrier receiving channel.

In another aspect, the end caps are adapted to include plug-in connectors which allow an electrical connection to the LEDs on the LED strip carrier simply by installing the end caps in position.

In another aspect, the LED strip carrier is readily exchangeable with another LED strip carrier of the same size, but having LEDs with different luminosity or colors mounted thereon, suitable for a different lighting environments or applications.

An illustrative embodiment will now be described in more detail with reference to the drawings.

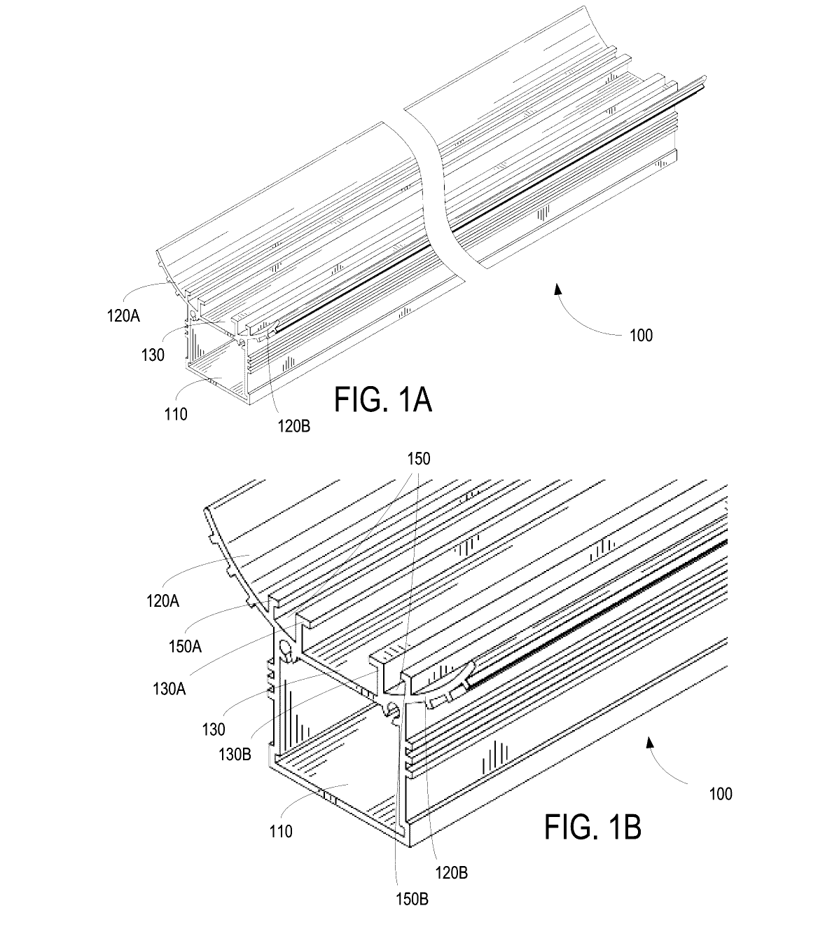

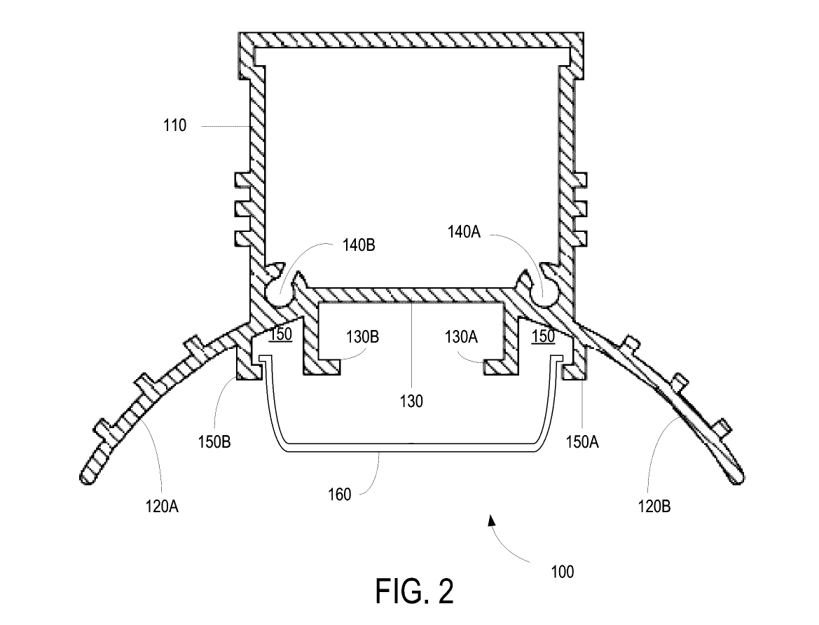

Referring to FIG. 1A, shown is an illustrative perspective view of an LED strip housing 100 in accordance with an illustrative embodiment. In this example, the LED strip housing 100 includes a generally elongate tube 110, with wings 120A, 120B extending from either side of the generally elongate tube 110. In this illustrative example, the generally elongate tube 110 is generally rectangular, and the wings 120A, 120B are curved and generally aligned with one side of the generally elongate rectangular tube 110. The inside of the generally elongate rectangular tube 110 provides space for electric wiring, circuit boards and electronics (not shown) required to power the LEDs. In use, the LED strip housing 100 is oriented such that the curved wings 120A, 120B are at the bottom of the apparatus (see FIG. 2), acting to direct light generally downwardly over an area to be illuminated.

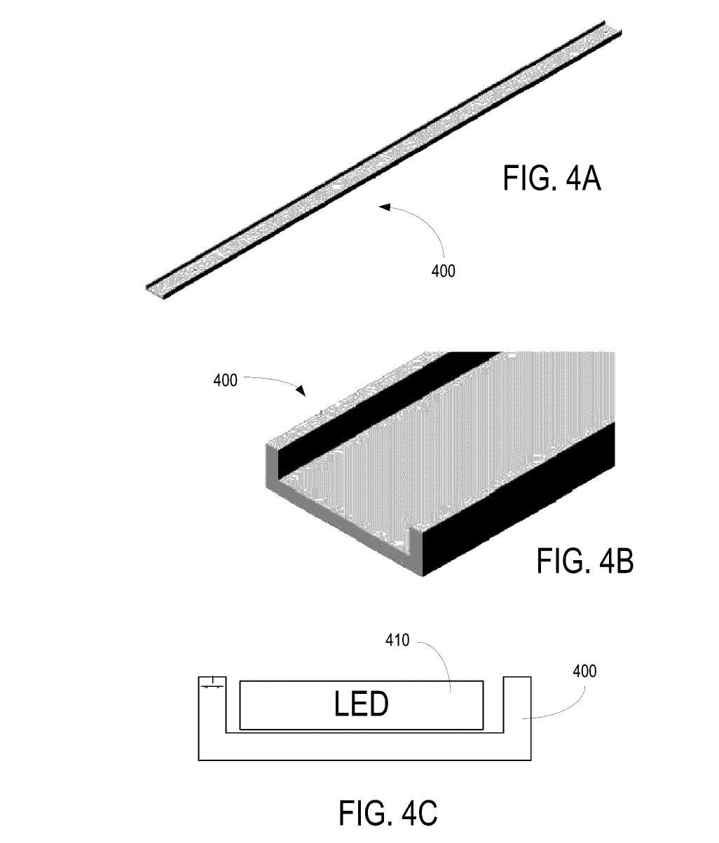

Still referring to FIG. 1A, and referencing the detailed view in FIG. 1B, the LED strip housing 110 further includes an LED strip carrier receiving channel 130 adapted to slidably receive an LED strip carrier 400 (see FIG. 4A) therein. In this example, the LED strip carrier receiving channel 130 includes retaining flanges 130A, 130B adapted to retain an LED strip carrier 400 in position with lateral extensions directed inwardly towards the carrier receiving channel 130, even with the LED strip housing 100 oriented for use with the LED strip carrier receiving channel 130 located at the bottom of the LED strip housing (as in FIG. 2).

An outer cover receiving channel 150 adapted to slidably receive an outer cover 160 (see FIG. 2) which covers and protects the LED strip carrier 400 received within the LED strip carrier receiving channel 130.

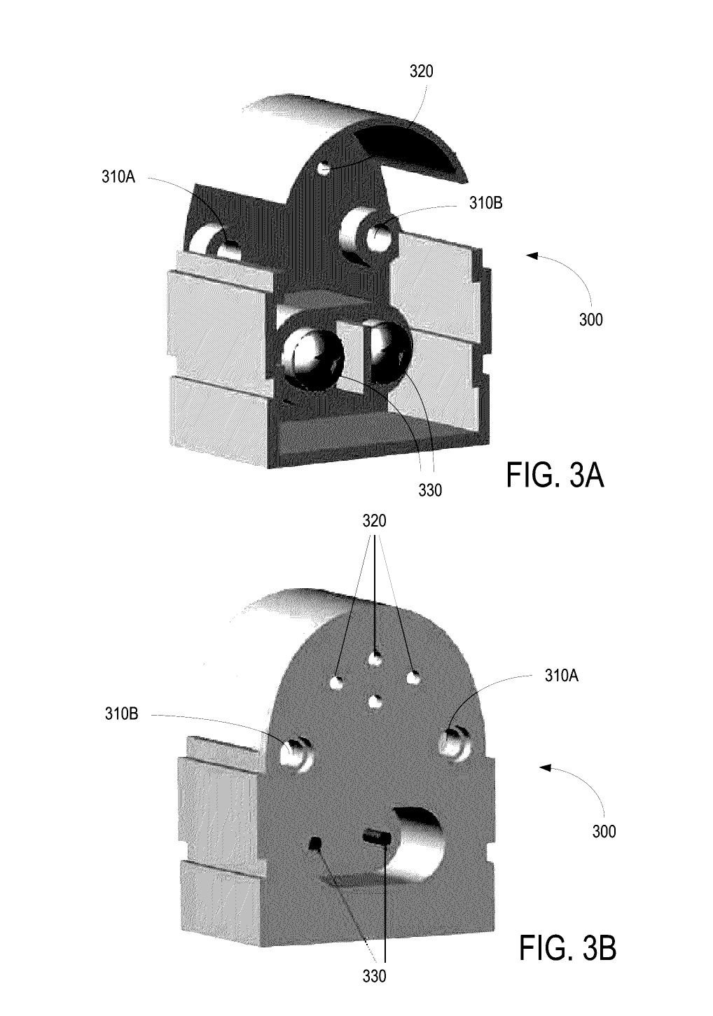

Now referring to FIG. 2, shown is a cross-sectional view of the LED strip housing 100 of FIGS. 1A and 1B, including a more detailed view of the LED strip carrier receiving channel 130, and the outer cover receiving channel 150 in accordance with an illustrative embodiment. In this detailed view, the profile of the LED strip housing 100 is shown including a generally rectangular tube 110 which provides space for electric wiring, circuit boards and electronics as described previously. At the bottom corners of the rectangular tube 100, generally circular shaped channels are adapted to receive fasteners, such as screws, which retain end caps 300 (see FIGS. 3A and 3B, for example) in place on either end of the LED strip housing 100.

Still referring to FIG. 2, the LED strip carrier receiving channel 130 is sized and positioned between the outer cover receiving channel 150 such that an LED strip carrier 400 (see FIGS. 4A-4C) can be slideably inserted or removed from one end, even as a transparent or translucent outer cover 160 remains installed in position in the outer cover receiving channel 150, covering the length of the LED strip carrier receiving channel 130. Consequently, the LED strip carrier 400 can readily be replaced by removing just one end cap 300 on one end of the LED strip housing 100.

Now referring to FIGS. 3A and 3B, shown are perspective views of end caps 300 in accordance with an illustrative embodiment. FIG. 3A shows a front perspective view, and FIG. 3B shows a corresponding rear perspective view. As shown, the end caps 300 include apertures 310A, 310B which are adapted to align with the generally circular shaped channels 140A, 140B (see FIG. 2) in the rectangular tube 110 to fasten end caps 300 on either end. Vent holes 320 may be provided to allow the minimal heat generated from the LEDs to escape through the end caps 300.

Still referring to FIGS. 3A and 3B, plug-in connectors 330 as shown are adapted to connect the LED strip to wiring, circuit boards and electronics within the rectangular tube (not shown). Contact points on the other side of the end caps 300 allow for electrical wire connections to a power source, such as household mains electricity for example, via a power cable.

Now referring to FIG. 4A, shown is a perspective view of an LED strip carrier 400 in accordance with an illustrative embodiment. In an embodiment, the LED strip carrier 400 is adapted to mount an LED strip thereon by fastening LEDs 410 to the strip. LEDs 410 may be fastened to the LED strip carrier 400 by means of an adhesive, such as fluorescent glue. It will be appreciated, however, that other adhesive means may be used to affix the LED strip in position in the LED strip carrier 400.

FIG. 4B shows a detailed perspective view of the LED strip carrier 400 of FIG. 4A, which is shaped as a channel in this illustrative embodiment. FIG. 4C shows a detailed cross-sectional view of the LED strip carrier 400. In an embodiment, the LED strip carrier 400 is shaped as a bracket, such that the length of the LED strip carrier remains relatively rigid. This allows the LED strip carrier 400 to retain its shape as an LED strip is mounted to it. Furthermore, the dative rigidity of the LED strip carrier 400 allows it to be slideably inserted and removed from the LED strip carrier receiving channel 130 within the LED strip housing 100, as described earlier.

The LED strip carrier 400 is adaptable to mount various types of LED strips having different luminosity and colors, suitable for different lighting environments and lighting applications.

Advantageously, the LED strip carrier 400 can be readily inserted and removed from one end of the LED strip housing 100 by simply removing one end cap 300, allowing efficient replacement of LED strips. This will save a significant amount of time, particularly in larger installation sites such as office buildings.

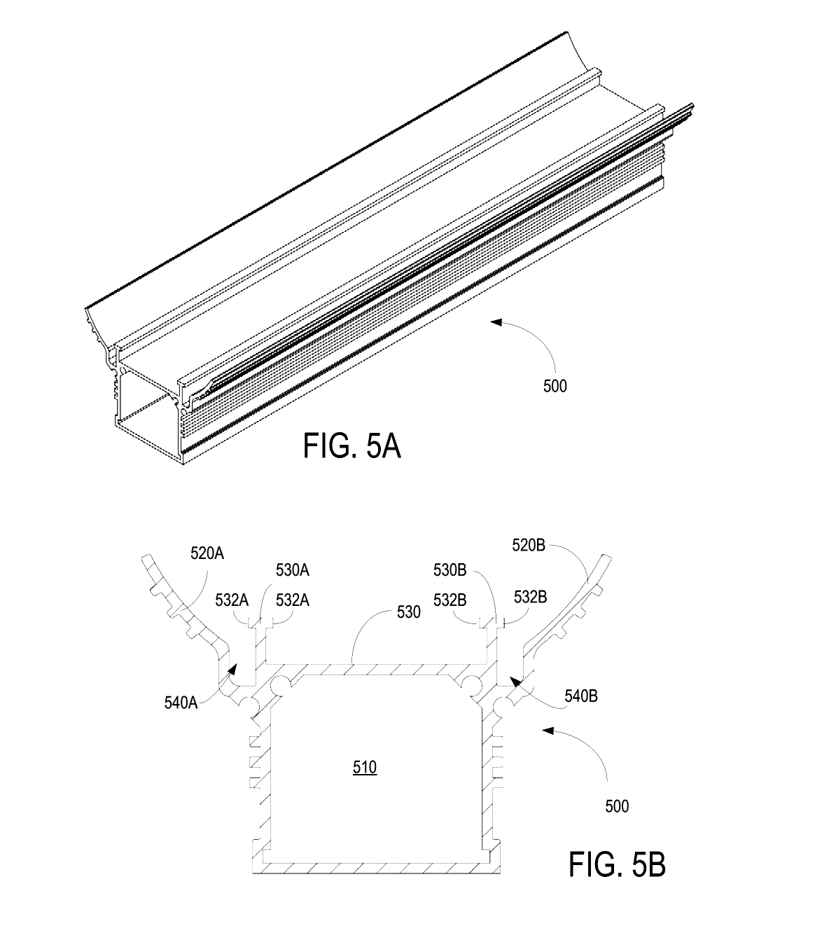

Now referring to FIGS. 5A and 5B, shown is an illustrative perspective view of an LED strip housing 500 in accordance with another illustrative embodiment. As detailed in FIG. 5B, the cross-sectional view of the LED strip housing of FIG. 5A again shows a generally elongate tube 510 with wings 520A, 520B. In this embodiment, the wings 520A, 520B are attached to the sides of the tube 510, and form channels 540A, 504B.

Still referring to FIG. 5B, the LED strip housing 500 further includes LED strip carrier receiving channel 530 having retaining flanges 530A, 530B with dual-sided lateral extensions 532A, 532B. The inner lateral extensions retain an LED strip carrier 400 slidably received within the LED strip carrier receiving channel 530 from either side of the LED strip housing 500. The outer lateral extensions may receive a cover (not shown) which may be positioned over the LED strip carrier 400 and LEDs 410 mounted thereon.

Advantageously, the LED strip housing 500 is adapted to allow LEDs to be quickly installed or replaced by removing one end cap 300 on one side to access the housing 500 and slidably insert or remove an LED strip carrier 400 into or out of the LED strip carrier receiving channel 530, without the need to remove any cover mounted over the LED lighting.

Thus, in an aspect, there is provided an LED strip housing apparatus, comprising: a generally elongate tube providing space for electric wiring, circuit boards and electronics; and an LED strip carrier receiving channel provided adjacent to the generally elongate tube and adapted to slidably receive an LED strip carrier.

In an embodiment, the LED strip carrier receiving channel is adapted to slidably receive and retain an LED strip carrier utilizing retaining flanges having extensions directed inwardly towards the LED strip carrier receiving channel.

In another embodiment, the LED strip carrier receiving channel is generally rectangular with an open side, and adapted to receive and retain an LED strip carrier shaped as a bracket.

In another embodiment, the LED strip housing apparatus further comprises an outer cover receiving channel for receiving a transparent or translucent outer cover which covers and protects the LED strip carrier received within the LED strip carrier receiving channel.

In another embodiment, the outer cover receiving channel is positioned adjacent to and outside of the LED strip carrier receiving channel, leaving the LED strip carrier receiving channel accessible from either end even with an outer cover installed in position.

In another embodiment, the LED strip housing apparatus of claim 5, further comprises end caps mountable to either end of the housing, the end caps adapted to connect the LED strip to wiring, circuit boards and electronics within the rectangular tube.

In another embodiment, the LED strip carrier receiving channel is accessible with an outer cover installed in position by removing one of the end caps.

In another embodiment, the LED strip housing apparatus further comprises wings extending from either side of the generally elongate tube, the wings positioned to direct light towards a direction.

In another embodiment, the wings are curved to form a generally concave shape.

In another embodiment, the apparatus comprises an integral one piece body.

In another embodiment, the LED strip carrier receiving channel is formed between retaining flanges that are a part of the integral one piece body.

In another embodiment, the retaining flanges include lateral extensions extending inwardly to retain the LED strip carrier within the LED strip carrier receiving channel.

In another embodiment, the retaining flanges further include lateral extensions extending outwardly to retain an outer cover installed over the LED strip carrier receiving channel.

In another embodiment, the integral one piece body of the apparatus further includes generally circular shaped channels for receiving fasteners.

While illustrative embodiments of the invention have been described above, it will be appreciate that various changes and modifications may be made without departing from the scope of the present invention.

1. An LED strip housing apparatus, comprising:
a generally elongate tube providing space for electric wiring, circuit boards and electronics; and
an LED strip carrier receiving channel provided adjacent to the generally elongate tube and adapted to slideably receive an LED strip carrier.

2. The LED strip housing apparatus of claim 1, wherein the LED strip carrier receiving channel is adapted to slidably receive and retain an LED strip carrier utilizing retaining flanges having extensions directed inwardly towards the LED strip carrier receiving channel.

3. The LED strip of claim 2, wherein the LED strip carrier receiving channel is generally rectangular with an open side, and adapted to receive and retain an LED strip carrier shaped as a bracket.

4. The LED strip housing apparatus of claim 1, further comprising an outer cover receiving channel for receiving a transparent or translucent outer cover which covers and protects the LED strip carrier received within the LED strip carrier receiving channel.

5. The LED strip housing apparatus of claim 4, wherein the outer cover receiving channel is positioned adjacent to and outside of the LED strip carrier receiving channel, leaving the LED strip carrier receiving channel accessible from either end even with an outer cover installed in position.

6. The LED strip housing apparatus of claim 5, further comprising end caps mountable to either end of the housing, the end caps adapted to connect the LED strip to wiring, circuit boards and electronics within the rectangular tube.

7. The LED strip housing apparatus of claim 6, wherein the LED strip carrier receiving channel is accessible with an outer cover installed in position by removing one of the end caps.

8. The LED strip housing apparatus of claim 1, further comprising wings extending from either side of the generally elongate tube, the wings positioned to direct light towards a direction.

9. The LED strip housing apparatus of claim 8, wherein the wings are curved to form a generally concave shape.

10. The LED strip housing apparatus of claim 1, wherein the apparatus comprises an integral one piece body.

11. The LED strip housing apparatus of claim 10, wherein the LED strip carrier receiving channel is formed between retaining flanges that are a part of the integral one piece body.

12. The LED strip housing apparatus of claim 11, wherein the retaining flanges include lateral extensions extending inwardly to retain the LED strip carrier within the LED strip carrier receiving channel.

13. The LED strip housing apparatus of claim 12, wherein the retaining flanges further include lateral extensions extending outwardly to retain an outer cover installed over the LED strip carrier receiving channel.

14. The LED strip housing apparatus of claim 10, wherein the integral one piece body of the apparatus further includes generally circular shaped channels for receiving fasteners.
